(19) United States
(12) Patent Application Publication
(10) Pub. No.: US 2022/0326716 A1
(43) Pub. Date: Oct. 13, 2022

(54) MOVEMENT CONTROL METHOD, MOVEMENT CONTROL APPARATUS, MOVEMENT CONTROL SYSTEM, AND PROGRAM

(71) Applicant: NEC Corporation, Minato-ku, Tokyo (JP)

(72) Inventor: Taichi KUMAGAI, Tokyo (JP)

(73) Assignee: NEC Corporation, Minato-ku, Tokyo (JP)

(21) Appl. No.: 17/641,030

(22) PCT Filed: Sep. 27, 2019
(86) PCT No.: PCT/JP2019/038320

§ 371 Date: Mar. 7, 2022

(51) Int. Cl. G05D 1/02

(52) U.S. Cl. CPC G05D 1/0223; G05D 1/0231; G05D 2201/0216

(57) ABSTRACT

In order to efficiently moves, a moving body which moves in response to a rotary motion of a caster, a movement control apparatus 100 includes: an obtaining section 111 configured to obtain information related to a state of a moving body 200 which moves in response to a rotary motion of a caster 210 having a swivel wheel 211 with an eccentric structure; a direction determination section 120 configured to determine a wheel advancing direction of the caster 210 based on the state information related to the state of the moving body 200; and a control section 130 configured to control for causing the moving body 200 to accelerate in a second advancing direction different from a first advancing direction which is based on a target moving path for the moving body 200, depending on the result of the determination.

### BACKGROUND

### Technical Field

The present invention relates to a movement control method, a movement control apparatus, a movement control system, and a program of a moving body which moves in response to a rotary motion of a caster having a swivel wheel with an eccentric structure.

### Background Art

A swivel caster is used for a moving body such as a cart being widely used at a production scene, such as a factory. Such a swivel caster has an eccentric structure in which the center of a wheel is deviated from a wheel pivot, and thus resistance is generated when a wheel advancing direction of the swivel caster is changed, i.e., when the wheel swivels. For example, even when the caster at rest is caused to advance in a direction opposite to the wheel moving direction, starting resistance increases. There is a problem that the cart cannot advance due to such great starting resistance. For such a problem, for example, PTL 1 discloses that, when a cart including a drive wheel and a swivel wheel receives a direction change instruction in a position where switchback is performed, the steering drive wheel is steered by a predetermined angle at stop to change an orientation of the swivel wheel.

### CITATION LIST

### Patent Literature

[PTL 1] JP 2006-134248 A

### SUMMARY

### Technical Problem

However, switchback is assumed to be performed in the technique disclosed in PTL 1. Thus, for example, in a position other than a position where switchback is performed, due to resistance caused in an advancing direction of a swivel wheel, a lot of energy is needed by generating a great driving force by a motor and the like in order to move a moving body such as a cart to a target moving path. Thus, there is a case where the moving body cannot be efficiently moved along the target moving path.

An example object of the present invention is to provide a movement control method, a movement control apparatus, a movement control system, and a program capable of efficiently moving, to a target moving path, a moving body which moves in response to a rotary motion of a caster having a swivel wheel with an eccentric structure.

### Solution to Problem

According to one aspect of the present invention, a movement control method includes: obtaining state information related to a state of a moving body which moves in response to a rotary motion of a caster having a swivel wheel with an eccentric structure; determining a wheel advancing direction of the caster based on the state information related to the state of the moving body; and controlling for causing the moving body to accelerate in a second advancing direction different from a first advancing direction which is based on a target moving path for the moving body, depending on the result of the determination related to the wheel advancing direction.

According to one aspect of the present invention, a movement control apparatus includes: an obtaining section configured to obtain state information related to a state of a moving body which moves in response to a rotary motion of a caster having a swivel wheel with an eccentric structure; a direction determination section configured to determine a wheel advancing direction of the caster based on the state information related to the state of the moving body; and a control section configured to control for causing the moving body to accelerate in a second advancing direction different from a first advancing direction which is based on a target moving path for the moving body, depending on the result of the determination related to the wheel advancing direction.

According to one aspect of the present invention, a movement control system includes: an acquisition means for obtaining state information related to a state of a moving body which moves in response to a rotary motion of a caster having a swivel wheel with an eccentric structure; a direction determination means for determining a wheel advancing direction of the caster based on the state information related to the state of the moving body; and a control means for controlling for causing the moving body to accelerate in a second advancing direction different from a first advancing direction which is based on a target moving path for the moving body, depending on the result of the determination related to the wheel advancing direction.

According to one aspect of the present invention, a program is a program causing a computer to execute processing including: obtaining state information related to a state of a moving body which moves in response to a rotary motion of a caster having a swivel wheel with an eccentric structure; determining a wheel advancing direction of the caster based on the state information related to the state of the moving body; and controlling for causing the moving body to accelerate in a second advancing direction different from a first advancing direction which is based on a target moving path for the moving body, depending on the result of the determination related to the wheel advancing direction.

### Advantageous Effects of Invention

According to one aspect of the present invention, a moving body which moves in response to a rotary motion of a caster having a swivel wheel with an eccentric structure can be efficiently moved to a target moving path. Note that, according to the present invention, instead of or together with the above effects, other effects may be exerted.

### BRIEF DESCRIPTION OF THE DRAWINGS

FIG. 1 is an explanatory diagram illustrating an example of a schematic configuration of a movement control system 1 according to an example embodiment of the present invention;

FIG. 2 is a block diagram illustrating an example of a hardware configuration of a movement control apparatus 100 according to a first example embodiment;

FIG. 3 is a block diagram illustrating an example of a configuration achieved by the movement control apparatus 100, transporting apparatuses 301 and 302, and an external sensor apparatus 400 in the movement control system 1 according to the first example embodiment;

FIGS. 4A and 4B are diagrams illustrating an example of a configuration of a caster 200 provided on a moving body 200;

FIG. 5 is a diagram illustrating an example of a wheel advancing direction 51 of the caster 210 provided on the moving body 200;

FIG. 6 is an explanatory diagram for describing an example of a case where the caster 210 is in a state of being difficult to swivel from the wheel advancing direction to the first advancing direction;

FIG. 7 is a diagram illustrating a flow of processing of the movement control apparatus 100 to which a first specific example is applied;

FIG. 8 is a diagram illustrating a flow of processing of the movement control apparatus 100 to which a second specific example is applied;

FIG. 9 is a block diagram illustrating an example of a schematic configuration of a movement control system 2 according to a second example embodiment; and

FIG. 10 is a diagram for describing a flow of processing performed by a movement control apparatus 100 according to the second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.
1. Summary of Example Embodiments of Present Invention
2. Configuration of System
3. First Example Embodiment
   3.1. Configuration of Movement Control Apparatus 100
   3.2. Configuration of Caster 210 Provided on Moving Body 200
4. Second Example Embodiment
   4.1. Configuration of Movement Control System 2
   4.2. Configuration of Movement Control Apparatus 100
   4.3. Operation Example
5. Other Example Embodiments

### 1. Summary of Example Embodiments of Present Invention

First, a summary of an example embodiments of the present invention will be described.

(1) Technical Issue

A swivel caster is used for a moving body such as a cart being widely used at a production scene, such as a factory. Such a swivel caster has an eccentric structure in which the center of a wheel is deviated from a wheel pivot, and thus resistance is generated when a wheel advancing direction of the swivel caster is changed, i.e., when the wheel swivels. For example, even when the caster at rest is caused to advance in a direction opposite to the wheel advancing direction, starting resistance increases. There is a problem that the cart cannot advance due to such great starting resistance.

For such a problem, for example, PTL 1 described above discloses that, when a cart including a drive wheel and a swivel wheel receives a direction change instruction in a position where switchback is performed, the steering drive wheel is steered by a predetermined angle at stop to change an orientation of the swivel wheel.

However, switchback is assumed to be performed in the technique disclosed in PTL 1. Thus, for example, in a position other than a position where switchback is performed, due to resistance caused in an advancing direction of a swivel wheel, a lot of energy is needed by generating a great driving force by a motor and the like in order to move a moving body such as a cart to a target moving path. In other words, there is a case where the moving body cannot be efficiently moved along the target moving path.

For the problem described above, for example, the following solutions are conceivable. A first solution is to reduce the amount of baggage carried by a cart (moving body) at once even when a wheel advancing direction of a caster is a direction opposite to an advancing direction of the cart. In this way, the starting resistance can be reduced, and thus transport of the cart can start. However, operation efficiency decreases in the first solution.

A second solution is to replace a caster with a caster having small resistance when a wheel advancing direction is changed. Furthermore, a third solution is to change a wheel advancing direction of a caster by lifting up a cart. However, a cost may increase due to a change in equipment and the like in the second and third solutions.

Thus, an example object of the present example embodiments is to efficiently move a moving body which moves in response to a rotary motion of a caster having a swivel wheel with an eccentric structure without performing the solutions 1 to 3 described above and the like, for example.

(2) Operation Example

For example, the example embodiments of the present invention obtains state information related to a state of a moving body which moves in response to a rotary motion of a caster having a swivel wheel with an eccentric structure, determines a wheel advancing direction of the caster based on the state information related to the state of the moving body, and controls for causing the moving body to accelerate in a second advancing direction different from a first advancing direction which is based on a target moving path for the moving body, depending on the result of the determination related to the wheel advancing direction.

In this way, for example, the moving body which moves in response to the rotary motion of the caster having the swivel wheel with the eccentric structure can be efficiently moved to the target moving path. Note that the operation example described above is one specific example of the example embodiments of the present invention, and the example embodiments of the present invention are, as a matter of course, not limited to the operation example described above.

### 2. Configuration of System

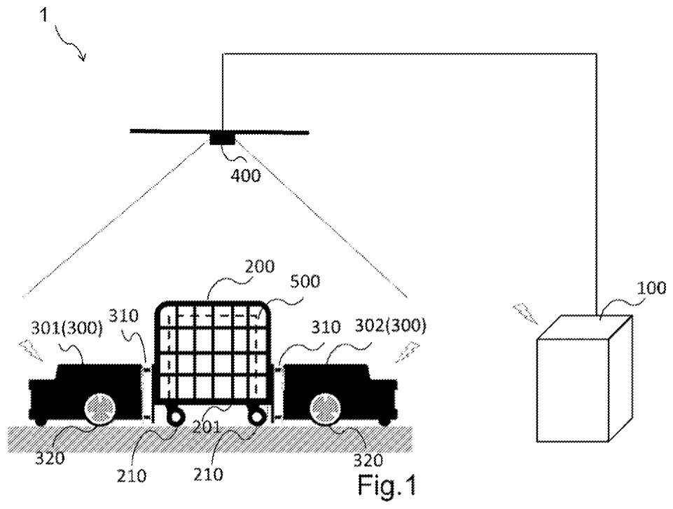

With reference to FIG. 1, an example of a configuration of a movement control system 1 according to an example embodiment of the present invention will be described. FIG. 1 is an explanatory diagram illustrating an example of a schematic configuration of the movement control system 1 according to the example embodiment of the present invention.

With reference to FIG. 1, the movement control system 1 includes a movement control apparatus 100, a moving body 200, a plurality of transporting apparatuses 301 and 302 (simply referred to as a “transporting apparatus 300” when there is no specific reason for distinction), and an external sensor apparatus 400.

(Movement Control Apparatus 100)

The movement control apparatus 100 is an apparatus for controlling movement of the moving body 200. For example, the movement control apparatus 100 transmits, to the transporting apparatus 300, instruction information for controlling movement of the moving body 200 by communicating with the transporting apparatus 300 and the external sensor apparatus 400. The instruction information includes, for example, a transport direction (hereinafter, also referred to as a transport instruction direction) and a transport speed (hereinafter, also referred to as a transport instruction speed) for instruction to the transporting apparatus 300.

(Moving Body 200)

The moving body 200 is, for example, a cart which moves in response to a rotary motion of a plurality of casters 210 provided on a main body bottom portion 201. In the moving body 200, for example, baggage 500 is loaded onto a space formed inside a main body of the moving body 200.

(Transporting Apparatus 300)

The transporting apparatus 300 is an Automated Guided Vehicle (AGV) which autonomously travels, and transports an object. The transporting apparatus 300 includes an elastic mechanism 310 for pressurizing the moving body 200, and a plurality of wheels 320 which move with a motor as a driving force. The transporting apparatus 300 controls an operation of the elastic mechanism 310 and the wheels 320 based on the instruction information from the movement control apparatus 100.

Specifically, as illustrated in FIG. 1, the transporting apparatus 300 (e.g., the transporting apparatus 301) transports the moving body 200 in cooperation with the other transporting apparatus 300 (e.g., the transporting apparatus 302).

The transporting apparatuses 301 and 302 are provided with, for example, the elastic mechanism 310 in which two plate materials are mechanically connected with a spring, as a means for sandwiching the moving body 200 by pressurizing the moving body 200 from opposite directions. Specifically, each of the elastic mechanisms 310 is provided on a main body of the transporting apparatuses 301 and 302 such that the elastic mechanism 310 can swivel. In other words, each of the elastic mechanisms 310 provided on the transporting apparatuses 301 and 302 such that the elastic mechanism 310 can swivel pressurizes the moving body 200 from opposite directions. The transporting apparatuses 301 and 302 each measure a distance between the plate materials constituting the elastic mechanism 310, and can thus detect a pressure amount to the moving body 200.

For example, the transporting apparatuses 301 and 302 rotationally drive the wheels 320 while maintaining a state of sandwiching the moving body 200 such that the pressure amount to the moving body 200 is a target value based on the pressure amount to the moving body 200, and can thus transport the moving body 200 such that the moving body 200 can swivel.

Note that the movement control system 1 is not limited to a case where the movement control system 1 includes the two transporting apparatuses 301 and 302, and, for example, one or three or more transporting apparatuses may transport the moving body 200. In the transporting apparatus 300, for example, a traction mechanism (not illustrated), which is not limited to the elastic mechanism 310, may transport the moving body 200. In description below, the description mainly centers around an example using the two transporting apparatuses 301 and 302.

(External Sensor Apparatus 400)

The external sensor apparatus 400 is, for example, a sensor apparatus which detects a position of the moving body 200. The external sensor apparatus 400 transmits detected data to the movement control apparatus 100. Specifically, the external sensor apparatus 400 is an apparatus which captures the inside of a field where the moving body 200 can move, and is configured to include a depth camera and/or a stereo camera, for example. The depth camera is a camera capable of capturing a depth image in which each pixel value of the image indicates a distance from the camera to a target object. The stereo camera is a camera which enables a measurement related to a depth direction of a target object by capturing the target object from a plurality of different directions by using a standard camera and a reference camera.

### 3. First Example Embodiment

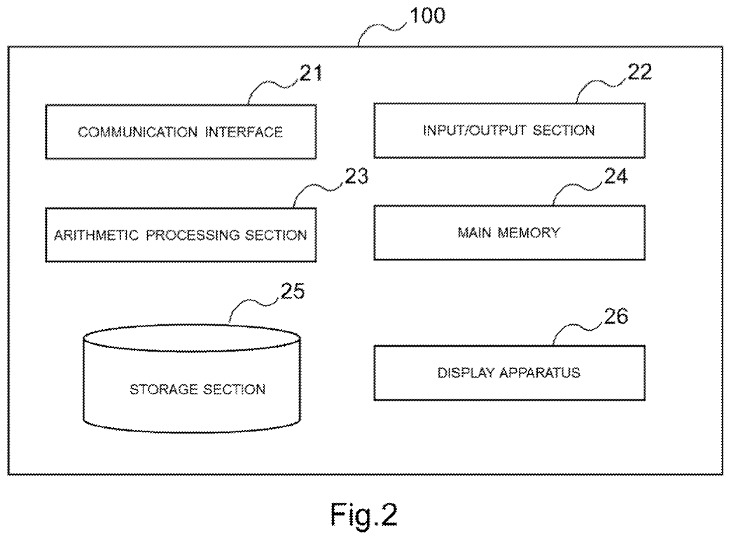

Then, a movement control apparatus 100 according to a first example embodiment will be described with reference to FIGS. 2 to 8.

<3.1. Configuration of Movement Control Apparatus 100>

FIG. 2 is a block diagram illustrating an example of a hardware configuration of the movement control apparatus 100 according to the first example embodiment. With reference to FIG. 2, the movement control apparatus 100 includes a communication interface 21, an input/output section 22, an arithmetic processing section 23, a main memory 24, and a storage section 25.

The communication interface 21 transmits and receives data to and from an external apparatus. For example, the communication interface 21 communicates with an external apparatus via a wired communication path or a wireless communication path.

The arithmetic processing section 23 is, for example, a Central Processing Unit (CPU), a Graphics Processing Unit (GPU), or the like. The main memory 24 is, for example, a Random Access Memory (RAM), a Read Only Memory (ROM), or the like. The storage section 25 is, for example, a Hard Disk Drive (HDD), a Solid State Drive (SSD), a memory card, or the like. The storage section 25 may be a memory such as a RAM and a ROM.

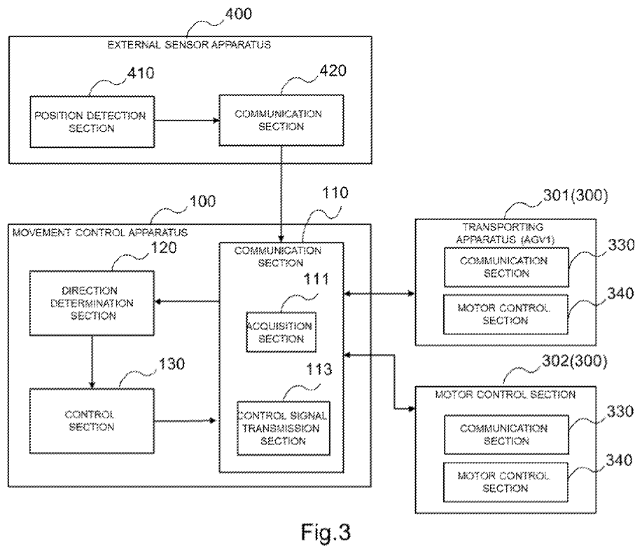

In the movement control apparatus 100, for example, a movement control program stored in the storage section 25 is read onto the main memory 24 and executed by the arithmetic processing section 23, and thus a functional section as illustrated in FIG. 3 is achieved. The program may be read onto the main memory 24 and then executed, or the program may be executed without being read onto the main memory 24. The main memory 24 and the storage section 25 also have a function of storing information and data held by a component included in the movement control apparatus 100.

The program described above can be stored by using various types of a non-transitory computer-readable medium and supplied to a computer. The non-transitory computer-readable medium includes various types of a tangible storage medium. Examples of the non-transitory computer-readable medium include a magnetic recording medium (e.g., a flexible disk, a magnetic tape, a hard disk drive), a magneto-optical recording medium (e.g., a magneto-optical disk), a Compact Disc-ROM (CD-ROM), a CD-Recordable (CD-R), a CD-ReWritable (CD-R/W), and a semiconductor memory (e.g., a mask ROM, a Programmable ROM (PROM), an Erasable PROM (EPROM), a flash ROM, and a RAM). The program may be supplied to a computer by various types of a transitory computer-readable medium. Examples of the transitory computer-readable medium include an electric signal, an optical signal, and an electromagnetic wave. The transitory computer-readable medium can supply the program to a computer via a wired communication path such as an electric wire and an optical fiber, or a wireless communication path.

A display apparatus 26 is an apparatus which displays a screen corresponding to drawing data processed by the arithmetic processing section 23, such as a Liquid Crystal Display (LCD), a Cathode Ray Tube (CRT) display, and a monitor.

FIG. 3 is a block diagram illustrating an example of a configuration achieved by the movement control apparatus 100, the transporting apparatuses 301 and 302, and the external sensor apparatus 400 in the movement control system 1 according to the first example embodiment. With reference to FIG. 3, the movement control apparatus 100 includes a communication section 110 including an obtaining section 111 and a control signal transmission section 113, a direction determination section 120, and a control section 130. The transporting apparatus 300 includes a communication section 330 and a motor control section 340. Furthermore, the external sensor apparatus 400 includes a position detection section 410 and a communication section 420.

<3.2. Configuration of Caster 210 Provided on Moving Body 200>

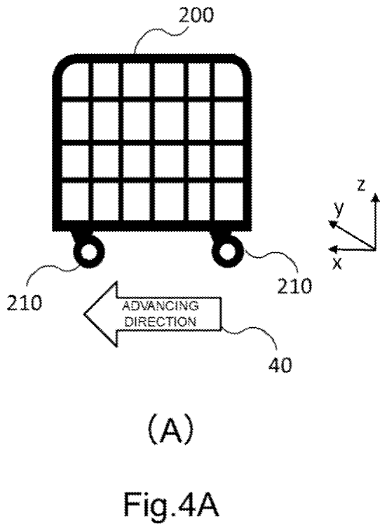

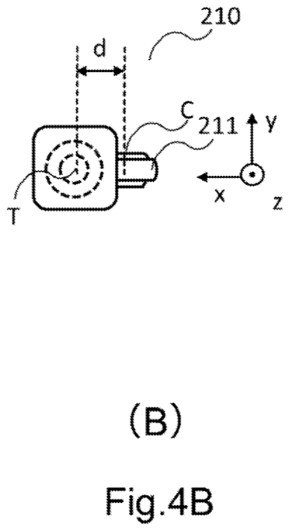

FIGS. 4A and 4B are diagrams illustrating an example of a configuration of the caster 210 provided on the moving body 200. FIG. 4A is a diagram illustrating the moving body 200 while moving in an advancing direction 40 being a +x-axis direction on three-dimensional space coordinates xyz which define a three-dimensional position of the moving body 200. FIG. 4B is an enlarged diagram of the caster 210 when the moving body 200 is viewed in a −z-axis direction, i.e., from up to down. With reference to FIG. 4B, the caster 210 includes a swivel wheel 211 with an eccentric structure. More specifically, the caster 210 includes the wheel 211 with the eccentric structure in which a center C of the wheel 211 is shifted with respect to a pivot T by an eccentric amount d.

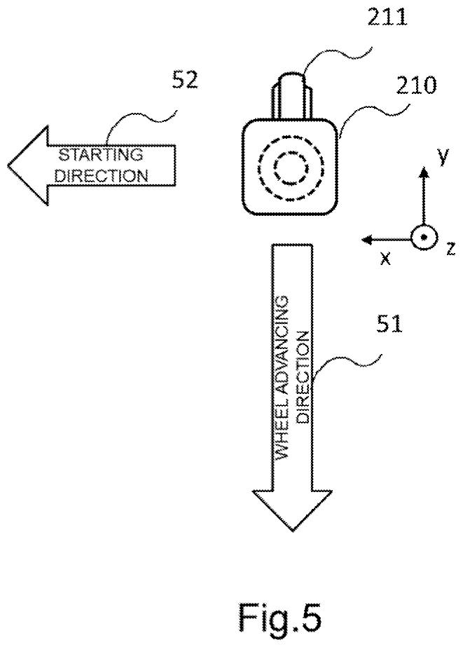

FIG. 5 is a diagram illustrating an example of a wheel advancing direction 51 of the caster 210 provided on the moving body 200. With reference to FIG. 5, the wheel advancing direction 51 of the caster 210 is a −y-axis direction. In such a state, even when the caster 210 is caused to start in the +x-axis direction (starting direction 52) perpendicular to the wheel advancing direction 51, due to resistance caused by the eccentric structure of the wheel 211 as described above, a lot of energy is needed by generating a great driving force by a motor and the like in order to cause the caster 210 to advance.

According to the first example embodiment, the movement control apparatus 100 (obtaining section 111) obtains state information related to a state of the moving body 200 which moves in response to a rotary motion of the caster 210 having the swivel wheel 211 with the eccentric structure. The movement control apparatus 100 (direction determination section 120) determines a wheel advancing direction of the caster 210 based on the state information related to the state of the moving body 200. Furthermore, the movement control apparatus 100 (control section 130) controls for causing the moving body 200 to accelerate in a second advancing direction different from a first advancing direction which is based on a target moving path for the moving body 200, depending on the result of the determination related to the wheel advancing direction.

Here, the first advancing direction is, for example, an advancing direction for moving the moving body 200 along the target moving path. On the other hand, the second advancing direction is an advancing direction in which the moving body 200 is deviated from the target moving path.

According to the first example embodiment, the moving body 200 can be efficiently moved by causing the moving body 200 to accelerate in the second advancing direction in which the moving body 200 is temporarily deviated from the target moving path, depending on a result of determination related to a wheel advancing direction.

(1) Specific Example

Next, the first example embodiment will be described with a first specific example and a second specific example indicated below.

(1-1) Specific Example 1

(1-1-1) Target of Direction Determination (Target of Movement State of Moving Body 200)

In the first specific example, an operation immediately before control for causing the moving body 200 to move in the first advancing direction is performed is subject to determination of a direction. The movement control apparatus 100 (direction determination section 120) specifies, from a moving direction of the moving body 200 before the control, a wheel advancing direction of the caster 210 immediately before the control. For example, the wheel advancing direction is specified as the same direction as the moving direction of the moving body 200 immediately before the control. Then, the movement control apparatus 100 (direction determination section 120) determines, based on the wheel advancing direction, whether the caster 210 is in a state of being difficult to swivel from the wheel advancing direction to the first advancing direction.

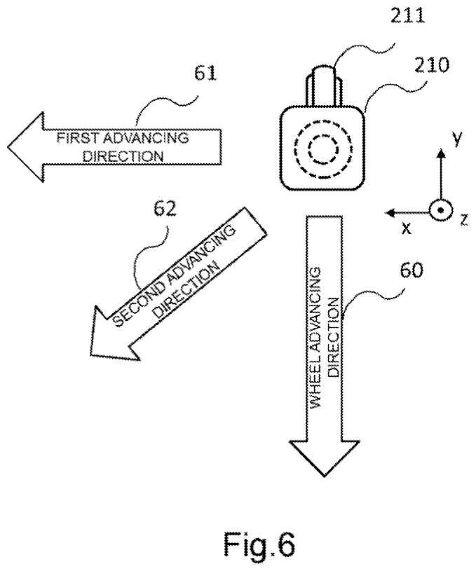

FIG. 6 is an explanatory diagram for describing an example of a case where the caster 210 is in a state of being difficult to swivel from the wheel advancing direction to the first advancing direction;

With reference to FIG. 6, for example, it is assumed that the movement control apparatus 100 (direction determination section 120) determines that a wheel advancing direction 60 of the caster 210 is the −y-axis direction. In this case, for example, the movement control apparatus 100 (control section 130) determines whether an angle formed between the wheel advancing direction 60 of the caster 210 and a first advancing direction 61 is equal to or less than a predetermined angle (e.g., 50 degrees).

When this applies to the example illustrated in FIG. 6, for example, the first advancing direction 61 is the +x-axis direction, and thus the angle formed between the wheel advancing direction 60 of the caster 210 and the first advancing direction 61 is 90 degrees (perpendicular). In this way, the movement control apparatus 100 (control section 130) can determine that the caster 210 is in a state of being difficult to swivel from the wheel advancing direction 60 to the first advancing direction 61.

(1-1-2) Information Used for Determination of Direction

The state information related to the state of the moving body 200, i.e., information used for determination of a direction is obtained as follows, for example.

Information Obtained from External Sensor Apparatus 400

The state information related to the state of the moving body 200 may include, for example, information obtained based on a captured image of the moving body 200 being captured by the external sensor apparatus 400. For example, the movement control apparatus 100 (obtaining section 111) can receive position information about the moving body 200 from the external sensor apparatus 400, and obtain state information about the moving body 200 based on a captured image of the moving body 200 by using a difference value between a plurality of pieces of the position information at different times.

Specifically, in the first specific example, the state information related to the state of the moving body 200 includes movement information based on a captured image of the moving body 200 being captured before control for causing the moving body 200 to move in the first advancing direction. In this case, the movement control apparatus 100 (direction determination section 120) specifies, from the movement information based on the captured image of the moving body 200 being captured before the control, a wheel advancing direction of the caster 210 before the control. Then, the movement control apparatus 100 (direction determination section 120) determines whether the caster 210 is in a state of being difficult to swivel from the wheel advancing direction to the first advancing direction.

Measurement Information Obtained from Transporting Apparatus 300

The state information related to the state of the moving body 200 may include, for example, measurement information obtained from one or more transporting apparatuses 300 which transport the moving body 200.

Specifically, the measurement information obtained from one or more of the transporting apparatuses 300 may include, for example, information related to a transport speed of one or more of the transporting apparatuses 300, and information related to torque generated for transporting the moving body 200 by a motor included in one or more of the transporting apparatuses 300.

Here, the transport speed is an actual transport speed achieved in response to driving of the motor by the transporting apparatus 300 (motor control section 340) according to instruction information from the movement control apparatus 100. The torque is actual torque achieved in response to driving of the motor by the transporting apparatus 300 (motor control section 340) according to instruction information from the movement control apparatus 100. These values are, for example, detected by the motor control section 340 and transmitted to the movement control apparatus 100 via the communication section 330.

As described above, when one or more of the transporting apparatuses 300 are the two transporting apparatuses 301 and 302 which sandwich the moving body 200 from opposite directions, the measurement information obtained from one or more of the transporting apparatuses 300 may include information related to a pressurized state to the moving body 200 by at least one transporting apparatus of the two transporting apparatuses 301 and 302 (a pressure amount to the moving body 200 by the elastic mechanism 310). The pressure amount to the moving body 200 by the elastic mechanism 310 is, for example, detected by a detection sensor and the like included in the elastic mechanism 310 and transmitted to the movement control apparatus 100 via the communication section 330.

Specifically, by communicating with the transporting apparatus 300, the movement control apparatus 100 (obtaining section 111) can receive the measurement information obtained from one or more of the transporting apparatuses 300.

In the first specific example below, description is given on an assumption that the state information related to the state of the moving body 200 includes the measurement information obtained from one or more of the transporting apparatuses 300 before control for causing the moving body 200 to move in the first advancing direction.

In this case, the movement control apparatus 100 (direction determination section 120) specifies, from the measurement information obtained from one or more of the transporting apparatuses 300 before the control, a wheel advancing direction of the caster 210 before the control. Then, the movement control apparatus 100 (direction determination section 120) determines whether the caster 210 is in a state of being difficult to swivel from the wheel advancing direction to the first advancing direction.

(1-1-3) Control of Moving Body 200

The movement control apparatus 100 (control section 130) controls for causing the moving body 200 to accelerate in the second advancing direction when the caster 210 is in a state of being difficult to swivel from the wheel advancing direction to the first advancing direction, depending on a result of determination by the direction determination section 120.

For example, in the first specific example, as illustrated in FIG. 6, the movement control apparatus 100 (control section 130) sets, as a second advancing direction 62, a direction in which an angle formed with the wheel advancing direction 60 is equal to or less than 50 degrees (e.g., 45 degrees), and controls for causing the moving body 200 to accelerate in the second advancing direction 62. In this way, movement of the moving body 200 can start.

Swiveling in Advancing Direction

As described above, when the moving body 200 accelerates in the second advancing direction, the movement control apparatus 100 (control section 130) controls for causing the caster 210 accelerating in the second advancing direction to turn into the first advancing direction. In this way, a trajectory of the moving body 200 temporarily deviated from the target moving path can converge to the target moving path.

(1-1-4) Flow of Processing

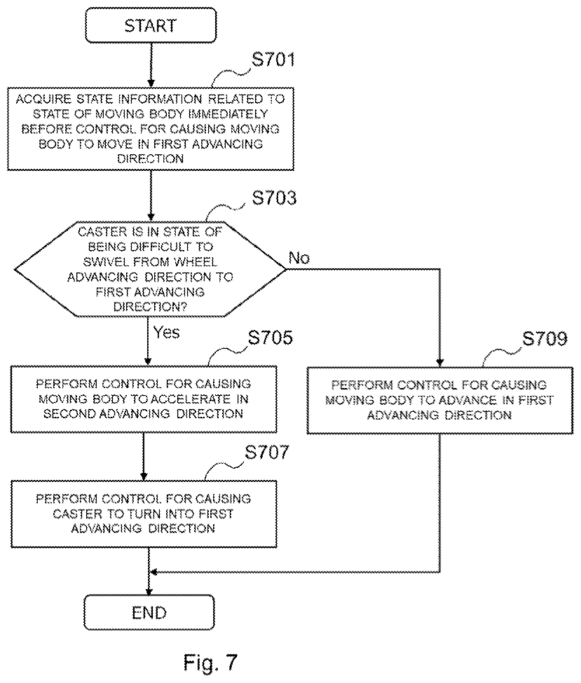

FIG. 7 is a diagram illustrating a flow of processing of the movement control apparatus 100 to which the first specific example is applied.

With reference to FIG. 7, in step S701, the movement control apparatus 100 (obtaining section 111) obtains state information related to a state of the moving body 200 before control for causing the moving body 200 to move in the first advancing direction. As described above, the state information related to the state of the moving body 200 is information transmitted from the external sensor apparatus 400 and the transporting apparatus 300.

In step S703, the movement control apparatus 100 (direction determination section 120) determines, based on the information obtained in step S701, whether the caster 210 is in a state of being difficult to swivel from the wheel advancing direction to the first advancing direction. When the caster 210 is in a state of being difficult to swivel (S703: Yes), the processing proceeds to step S705. When the caster 210 is in a state of being easy to swivel (S703: No), the processing proceeds to step S709 without proceeding to steps S705 and S707.

In step S705, the movement control apparatus 100 (control section 130) controls for causing the moving body 200 to accelerate in the second advancing direction. Specifically, the movement control apparatus 100 (control section 130) generates instruction information for causing the moving body 200 to accelerate in the second advancing direction, and transmits the instruction information to the transporting apparatus 300 by the control signal transmission section 113. Subsequently, the processing proceeds to step S707.

In step S705, the movement control apparatus 100 (control section 130) controls for causing the caster 210 accelerating in the second advancing direction to turn into the first advancing direction in response to the control in step S707. Specifically, the movement control apparatus 100 (control section 130) generates instruction information for causing the caster 210 to turn into the first advancing direction when it is determined that the moving body 200 accelerates in the second advancing direction based on the information transmitted from the transporting apparatus 300, and transmits the instruction information to the transporting apparatus 300 by the control signal transmission section 113. Subsequently, the processing illustrated in FIG. 7 is terminated.

On the other hand, in step S709, the movement control apparatus 100 (control section 130) controls for causing the moving body 200 to advance in the first advancing direction, and the processing illustrated in FIG. 7 is terminated.

The processing illustrated in FIG. 7 determines a wheel advancing direction of the caster 210 based on a state of the moving body before control for causing the moving body 200 to move in the first advancing direction, and controls for causing the moving body 200 to accelerate in the second advancing direction, depending on the result of the determination. In this way, by temporarily causing the moving body 200 to accelerate in the second advancing direction, the moving body 200 can be efficiently moved to a target moving path.

(1-2) Second Specific Example

(1-2-1) Target of Direction Determination (Target of Movement State of Moving Body 200)

In the second specific example, a state of the moving body 200 being subject to determination of a direction is different from that in the first specific example, and is a movement state of the moving body 200 in response to control for causing the moving body 200 to move in the first advancing direction, i.e., a movement state of the moving body 200 after the control. In this case, the movement control apparatus 100 (direction determination section 120) determines that the caster 210 is in a state of being difficult to swivel from the wheel advancing direction to the first advancing direction when the state of the moving body 200 in response to the control for causing the moving body 200 to move in the first advancing direction does not satisfy a predetermined operation condition as described below.

(1-2-2) Information Used for Determination of Direction

The state information related to the state of the moving body 200, i.e., information used for determination of a direction is obtained as follows, for example.

Information Obtained from External Sensor Apparatus 400

The state information related to the state of the moving body 200 may include, for example, information obtained from movement information based on a captured image of the moving body 200 being captured by the external sensor apparatus 400. In other words, the movement control apparatus 100 (obtaining section 111) can receive position information about the moving body 200 from the external sensor apparatus 400, and obtain movement information based on a captured image of the moving body 200 by using a difference value between a plurality of pieces of the position information at different times.

Specifically, in the second specific example, the state information related to the state of the moving body 200 includes movement information based on a captured image of the moving body 200 being captured immediately after control for causing the moving body 200 to move in the first advancing direction. In this case, the movement control apparatus 100 (direction determination section 120) determines that the caster 210 is in a state of being difficult to swivel from the wheel advancing direction to the first advancing direction when, for example, the movement information (e.g., a movement distance in which the moving body 200 moves) based on the captured image of the moving body 200 being captured immediately after the control is smaller than a movement distance (threshold value) of the moving body 200 expected as an output value in response to the control for causing the moving body 200 to move in the first advancing direction.

Measurement Information Obtained from Transporting Apparatus 300

The state information related to the state of the moving body 200 may include, for example, measurement information obtained from one or more transporting apparatuses 300 which transport the moving body 200.

Specifically, the measurement information obtained from one or more of the transporting apparatuses 300 may include, for example, information related to a transport speed of one or more of the transporting apparatuses 300, and information related to torque generated for transporting the moving body 200 by a motor included in one or more of the transporting apparatuses 300.

Here, the transport speed is an actual transport speed achieved in response to driving of the motor by the transporting apparatus 300 (motor control section 340) according to instruction information from the movement control apparatus 100. The torque is actual torque achieved in response to driving of the motor by the transporting apparatus 300 (motor control section 340) according to instruction information from the movement control apparatus 100. These values are, for example, detected by the motor control section 340 and transmitted to the movement control apparatus 100 via the communication section 330.

As described above, when one or more of the transporting apparatuses 300 are the two transporting apparatuses 301 and 302 which sandwich the moving body 200 from opposite directions, the measurement information obtained from one or more of the transporting apparatuses 300 may include information related to a pressurized state to the moving body 200 by at least one transporting apparatus of the two transporting apparatuses 301 and 302 (a pressure amount to the moving body 200 by the elastic mechanism 310). The pressure amount to the moving body 200 by the elastic mechanism 310 is, for example, detected by a detection sensor and the like included in the elastic mechanism 310 and transmitted to the movement control apparatus 100 via the communication section 330.

In description of the second specific example below, description is given on an assumption that the state information related to the state of the moving body 200 includes the measurement information obtained from one or more of the transporting apparatuses 300 immediately after the control for causing the moving body 200 to move in the first advancing direction.

In this case, the movement control apparatus 100 (direction determination section 120) determines that the caster 210 is in a state of being difficult to swivel from the wheel advancing direction to the first advancing direction when, for example, the measurement information obtained from one or more of the transporting apparatuses 300 immediately after the control does not satisfy a condition expected as an output value in response to the control for causing the moving body 200 to move in the first advancing direction.

For example, when the transport speed immediately after the control is lower than a predetermined threshold value, it is determined that the caster 210 is in a state of being difficult to swivel from the wheel advancing direction to the first advancing direction. For example, when the torque immediately after the control is greater than a predetermined threshold value, resistance to the transporting apparatus 300 from the caster 210 is significantly great, and thus it is determined that the caster 210 is in a state of being difficult to swivel from the wheel advancing direction to the first advancing direction. Furthermore, for example, when a pressure amount to the moving body 200 by the elastic mechanism 310 immediately after the control is greater than a predetermined pressure amount, resistance to the transporting apparatus 300 from the caster 210 is significantly great, and thus it is determined that the caster 210 is in a state of being difficult to swivel from the wheel advancing direction to the first advancing direction.

(1-2-3) Control of Moving Body 200

The movement control apparatus 100 (control section 130) controls for causing the moving body 200 to accelerate in the second advancing direction when the caster 210 is in a state of being difficult to swivel from the wheel advancing direction to the first advancing direction, depending on a result of determination by the direction determination section 120.

Specifically, in the second specific example, the movement control apparatus 100 (control section 130) may control so as to move the moving body 200 with, as the second advancing direction, any direction different from the first advancing direction. In this case, when the moving body 200 cannot be moved, control may be performed so as to move the moving body 200 in an advancing direction different from the second advancing direction.

For example, the movement control apparatus 100 (control section 130) sets, as the second advancing direction, a direction in which an angle formed with the first advancing direction is equal to or more than 30 degrees and equal to or less than 60 degrees (e.g., 45 degrees), and controls for causing the moving body 200 to accelerate in the second advancing direction. In this way, movement of the moving body 200 can start.

Furthermore, when the moving body 200 is sandwiched between the two transporting apparatuses 301 and 302 and moved as described above, the second advancing direction may be determined as follows. In other words, the movement control apparatus 100 (control section 130) may set, as the second advancing directions for respective transporting apparatuses 301 and 302, directions each shifted by 45 degrees from the first advancing direction. The movement control apparatus 100 (control section 130) may set the second advancing direction for the transporting apparatus 300 (e.g., the transporting apparatus 302) on a back side in the first advancing direction while the transporting apparatus 300 (e.g., the transporting apparatus 301) on a front side in the first advancing direction remains at rest.

Swiveling in Advancing Direction

As described above, when the moving body 200 accelerates in the second advancing direction, the movement control apparatus 100 (control section 130) controls for causing the caster 210 accelerating in the second advancing direction to turn into the first advancing direction. In this way, a trajectory of the moving body 200 temporarily deviated from the target moving path can converge to the target moving path.

(1-2-4) Flow of Processing

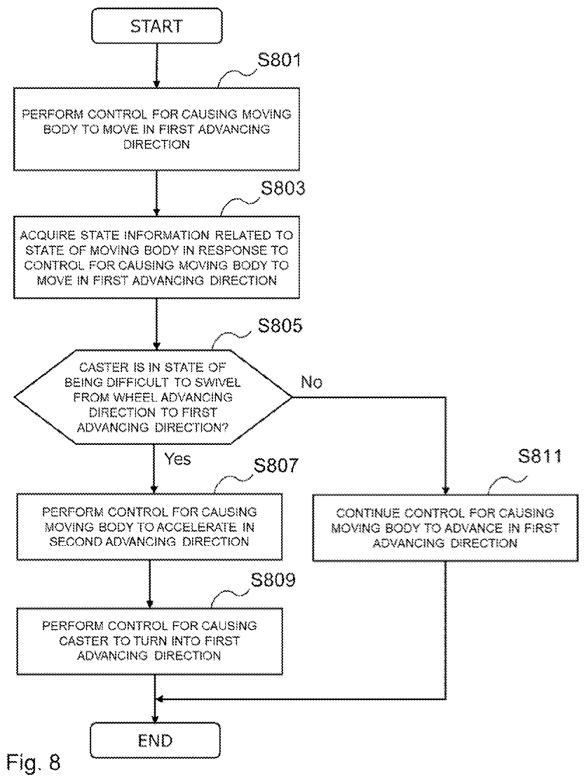

FIG. 8 is a diagram illustrating a flow of processing of the movement control apparatus 100 to which the second specific example is applied.

With reference to FIG. 8, in step S801, the movement control apparatus 100 (control section 130) controls for causing the moving body 200 to move in the first advancing direction. Specifically, the movement control apparatus 100 (control section 130) generates instruction information (including a transport instruction direction, a transport instruction speed, and the like) for causing the moving body 200 to move in the first advancing direction, and transmits the instruction information to the transporting apparatus 300 by the control signal transmission section 113. Subsequently, the processing proceeds to step S803.

In step S803, the movement control apparatus 100 (obtaining section 111) obtains state information related to a state of the moving body 200 in response to the control in step S801, and the processing proceeds to step S805. Here, as described above, the state information related to the state of the moving body 200 is information transmitted from the external sensor apparatus 400 and the transporting apparatus 300.

In step S805, the movement control apparatus 100 (direction determination section 120) determines, based on the information obtained in step S803, whether the caster 210 is in a state of being difficult to swivel from the wheel advancing direction to the first advancing direction. When the caster 210 is in a state of being difficult to swivel (S805: Yes), the processing proceeds to step S807. When the caster 210 is in a state of being easy to swivel (S805: No), the processing proceeds to step S811 without proceeding to steps S807 and S809.

In step S807, the movement control apparatus 100 (control section 130) controls for causing the moving body 200 to accelerate in the second advancing direction. Specifically, the movement control apparatus 100 (control section 130) generates instruction information for causing the moving body 200 to accelerate in the second advancing direction, and transmits the instruction information to the transporting apparatus 300 by the control signal transmission section 113. Subsequently, the processing proceeds to step S809.

In step S809, the movement control apparatus 100 (control section 130) controls for causing the caster 210 accelerating in the second advancing direction to turn into the first advancing direction in response to the control in step S807. Specifically, the movement control apparatus 100 (control section 130) generates instruction information for causing the caster 210 to turn into the first advancing direction when it is determined that the moving body 200 accelerates in the second advancing direction based on the information transmitted from the transporting apparatus 300, and transmits the instruction information to the transporting apparatus 300 by the control signal transmission section 113. Subsequently, the processing illustrated in FIG. 8 is terminated.

On the other hand, in step S811, the movement control apparatus 100 (control section 130) continues control similar to that in step S801, i.e., control for causing the moving body 200 to advance in the first advancing direction, and the processing illustrated in FIG. 8 is terminated.

The processing illustrated in FIG. 8 determines the wheel advancing direction of the caster 210 based on a movement state of the moving body 200 in response to control for causing the moving body 200 to move in the first advancing direction, and controls for causing the moving body 200 to accelerate in the second advancing direction, depending on the result of the determination. In this way, by temporarily causing the moving body 200 to accelerate in the second advancing direction, the moving body 200 can be efficiently moved to a target moving path.

(2) Example Alterations

The first example embodiment is not limited to the specific examples as described above, and various alterations can be made.

For example, regardless of whether the direction determination section 120 can determine the wheel advancing direction of the caster 210, for example, when the moving body 200 starts to move, the movement control apparatus 100 may control for causing the moving body 200 to accelerate in the second advancing direction. When the direction determination section 120 cannot determine the wheel advancing direction of the caster 210, the movement control apparatus 100 may control for causing the moving body 200 to accelerate in the second advancing direction.

Here, a case where determination related to the wheel advancing direction of the caster 210 cannot be performed is assumed to be a case where the movement control apparatus 100 (obtaining section 111) fails to obtain movement information about the moving body 200 based on a captured image because the external sensor apparatus 400 fails to capture the moving body 200, for example, due to an obstacle or the like, or other cases.

In such a case, the movement control apparatus 100 (control section 130) controls for temporarily causing the moving body 200 to accelerate in the second advancing direction (e.g., any direction different from the first advancing direction) even if the caster 210 can swivel into the first advancing direction. Subsequently, when the moving body 200 moves, the movement control apparatus 100 (control section 130) controls for causing the moving body 200 to swivel into the first advancing direction. On the other hand, when the moving body 200 does not move, the movement control apparatus 100 (control section 130) may control for causing the moving body 200 to accelerate in another advancing direction different from the first and second advancing directions.

### 4. Second Example Embodiment

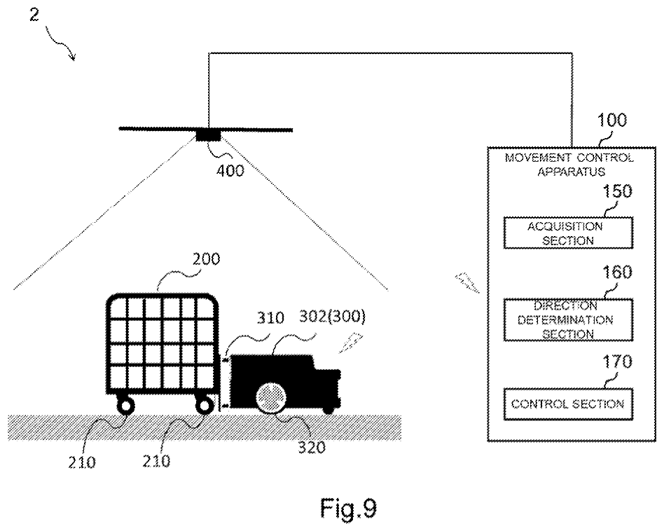

Then, a description will be given of a second example embodiment according to the present invention with reference to FIG. 9. The above-described first example embodiment is a concrete example embodiment, whereas the second example embodiment is a more generalized example embodiment.

<4.1. Configuration of Movement Control System 2>

FIG. 9 is a block diagram illustrating an example of a schematic configuration of a movement control system 2 according to the second example embodiment. With reference to FIG. 9, the movement control system 2 includes a movement control apparatus 100, a moving body 200 provided with casters 210, a transporting apparatus 300, and an external sensor apparatus 400.

The movement control apparatus 100 is an apparatus for controlling movement of the moving body 200. For example, the movement control apparatus 100 controls movement of the moving body 200 by communicating with the transporting apparatus 300 and the external sensor apparatus 400. The moving body 200 moves in response to a rotary motion of the plurality of casters 210. The transporting apparatus 300 autonomously travels, and transports the moving body 200. The external sensor apparatus 400 is, for example, a sensor apparatus which detects a position of the moving body 200.

<4.2. Configuration of Movement Control Apparatus 100>

The movement control apparatus 100 includes an obtaining section 150, a direction determination section 160, and a control section 170.

The obtaining section 150, the direction determination section 160, and the control section 170 may be implemented with one or more processors, a memory (e.g., a nonvolatile memory and/or a volatile memory) and/or a hard disk. The obtaining section 150, the direction determination section 160, and the control section 170 may be implemented with the same processor or may be implemented with separate processors. The memory may be included in the one or more processors or may be provided outside the one or more processors.

<4.3. Operation Example>

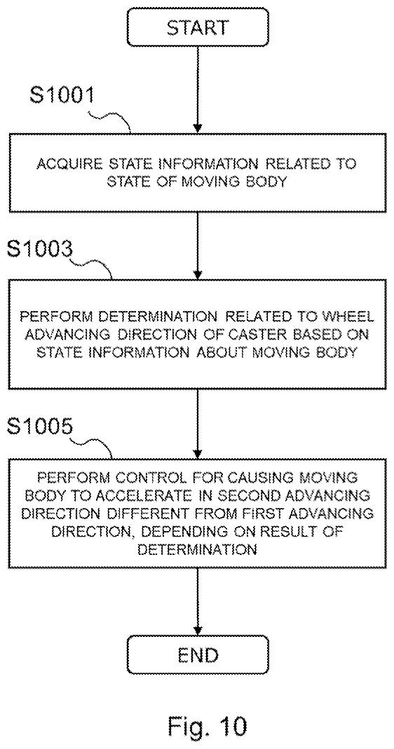

An operation example according to the second example embodiment will be described. FIG. 10 is a diagram for describing a flow of processing performed by the movement control apparatus 100 according to the second example embodiment.

According to the second example embodiment, the movement control apparatus 100 (obtaining section 150) obtains state information related to a state of the moving body 200 which moves in response to a rotary motion of the caster 210 having a swivel wheel with an eccentric structure (step S1001). The state information is, for example, detected by the external sensor apparatus 400 and transmitted to the movement control apparatus 100. The movement control apparatus 100 (direction determination section 160) determines a wheel advancing direction of the caster 210 based on the state information related to the state of the moving body 200 (step S1003). Furthermore, the movement control apparatus 100 (control section 170) controls for causing the moving body 200 to accelerate in a second advancing direction different from a first advancing direction which is based on a target moving path for the moving body 200, depending on the result of the determination related to the wheel advancing direction (step S1005). Specifically, the movement control apparatus 100 performs, on the transporting apparatus 300, a transport instruction for causing the moving body 200 to accelerate in the second advancing direction.

Relationship with First Example Embodiment

As an example, the obtaining section 150, the direction determination section 160, and the control section 170 according to the second example embodiment may perform operation of the obtaining section 111, the direction determination section 120, and the control section 130 according to the first example embodiment, respectively. In this case, the descriptions of the first example embodiment may be applicable to the second example embodiment.

Note that the second example embodiment is not limited to this example.

The second example embodiment has been described above. For example, the second example embodiment can efficiently move, to a target moving path, a moving body which moves in response to a rotary motion of a caster having a swivel wheel with an eccentric structure.

### 5. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, in the Specification, an example in which a moving body is transported by using mainly two transporting apparatuses is described, but the present invention may be applied to an example in which a moving body is transported by using a single transporting apparatus or three or more transporting apparatuses. The steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus including constituent elements (e.g., the obtaining section, the direction determination section, and/or the control section) of the movement control apparatus described in the Specification (e.g., one or more apparatuses (or units) among a plurality of apparatuses (or units) constituting the movement control apparatus or a module for one of the plurality of apparatuses (or units)) may be provided. Moreover, methods including processing of the constituent elements may be provided, and programs for causing a processor to execute processing of the constituent elements may be provided. Moreover, non-transitory computer-readable recording media (non-transitory computer-readable media) having recorded thereon the programs may be provided. It is apparent that such apparatuses, modules, methods, programs, and non-transitory computer-readable recording media are also included in the present invention.

The whole or part of the example embodiments disclosed above can be described as, but not limited to, the following supplementary notes.

### (Supplementary Note 1)

A movement control method comprising:

obtaining state information related to a state of a moving body which moves in response to a rotary motion of a caster having a swivel wheel with an eccentric structure;

determining a wheel advancing direction of the caster based on the state information related to the state of the moving body; and

controlling for causing the moving body to accelerate in a second advancing direction different from a first advancing direction which is based on a target moving path for the moving body, depending on the result of the determination related to the wheel advancing direction.

### (Supplementary Note 2)

The movement control method according to supplementary note 1, wherein controlling the moving body includes controlling for causing the moving body to accelerate in the second advancing direction when it is determined that the caster is in a state of being difficult to swivel from the wheel advancing direction to the first advancing direction, depending on the result of the determination.

### (Supplementary Note 3)

The movement control method according to supplementary note 1 or 2, further comprising

controlling for causing the caster accelerating in the second advancing direction to turn into the first advancing direction.

(Supplementary Note 4)

The movement control method according to any one of supplementary notes 1 to 3, wherein the state of the moving body is a movement direction of the moving body before control for causing the moving body to move in the first advancing direction.

### (Supplementary Note 5)

The movement control method according to supplementary note 4, wherein determining the wheel advancing direction of the caster includes determining that it is determined that the caster is in a state of being difficult to swivel from the wheel advancing direction to the first advancing direction in response to the state of the moving body before control for causing the moving body to move in the first advancing direction.

### (Supplementary Note 6)

The movement control method according to any one of supplementary notes 1 to 3, wherein the state of the moving body is a movement state of the moving body in response to control for causing the moving body to move in the first advancing direction.

### (Supplementary Note 7)

The movement control method according to supplementary note 5, wherein determining the wheel advancing direction of the caster includes determining that the caster is in a state of being difficult to swivel from the wheel advancing direction to the first advancing direction when the state of the moving body in response to the control for causing the moving body to move in the first advancing direction does not satisfy a predetermined operation condition.

### (Supplementary Note 8)

The movement control method according to any one of supplementary notes 1 to 7, wherein the state information related to the state of the moving body includes information obtained from movement information based on a captured image of the moving body.

### (Supplementary Note 9)

The movement control method according to any one of supplementary notes 1 to 8, wherein the state information related to the state of the moving body includes measurement information obtained from one or more transporting apparatuses which transport the moving body.

### (Supplementary Note 10)

The movement control method according to supplementary note 9, wherein the measurement information obtained from one or more of the transporting apparatuses includes information related to a transport speed of one or more of the transporting apparatuses.

### (Supplementary Note 11)

The movement control method according to supplementary note 9 or 10, wherein the measurement information obtained from one or more of the transporting apparatuses includes information related to torque generated for transporting the moving body by a motor included in one or more of the transporting apparatuses.

### (Supplementary Note 12)

The movement control method according to any one of supplementary notes 9 to 11, wherein the one or more of the transporting apparatuses include two transporting apparatuses which transport the moving body in cooperation with each other.

### (Supplementary Note 13)

The movement control method according to any one of supplementary notes 1 to 12, further comprising

controlling for causing the moving body to accelerate in the second advancing direction when determination related to the wheel advancing direction of the caster is not successfully performed.

### (Supplementary Note 14)

A movement control apparatus comprising:

an obtaining section configured to obtain state information related to a state of a moving body which moves in response to a rotary motion of a caster having a swivel wheel with an eccentric structure;

a direction determination section configured to determine a wheel advancing direction of the caster based on the state information related to the state of the moving body; and

a control section configured to control for causing the moving body to accelerate in a second advancing direction different from a first advancing direction which is based on a target moving path for the moving body, depending on the result of the determination related to the wheel advancing direction.

### (Supplementary Note 15)

The movement control apparatus according to supplementary note 14, wherein the control section is configured to transmit instruction information for controlling the moving body to one or more transporting apparatuses which transport the moving body.

### (Supplementary Note 16)

The movement control apparatus according to supplementary note 15, wherein the obtaining section is configured to receive the state information related to the state of the moving body from one or more of the transporting apparatuses.

### (Supplementary Note 17)

The movement control apparatus according to any one of supplementary notes 14 to 16, wherein the obtaining section is configured to receive the state information related to the state of the moving body from an image-capturing apparatus which captures the moving body.

### (Supplementary Note 18)

The movement control apparatus according to any one of supplementary notes 14 to 16, wherein the control section is configured to controls for causing the moving body to accelerate in the second advancing direction when it is determined that the caster is in a state of being difficult to swivel from the wheel advancing direction to the first advancing direction, depending on the result of the determination.

### (Supplementary Note 19)

The movement control apparatus according to any one of supplementary notes 14 to 18, wherein the control section is configured to further control for causing the caster to accelerate in the second advancing direction to turn into the first advancing direction.

### (Supplementary Note 20)

The movement control apparatus according to any one of supplementary notes 14 to 19, wherein the state of the moving body is a movement direction of the moving body before control for causing the moving body to move in the first advancing direction.

### (Supplementary Note 21)

The movement control apparatus according to supplementary note 20, wherein the direction determination section includes determining that the caster is in a state of being difficult to swivel from the wheel advancing direction to the first advancing direction in response to the moving direction of the moving body before control for causing the moving body to move in the first advancing direction.

### (Supplementary Note 22)

The movement control apparatus according to any one of supplementary notes 14 to 19, wherein the state of the moving body is a movement state of the moving body in response to control for causing the moving body to move in the first advancing direction.

### (Supplementary Note 23)

A movement control system comprising:

an acquisition means for obtaining state information related to a state of a moving body which moves in response to a rotary motion of a caster having a swivel wheel with an eccentric structure;

a direction determination means for determining a wheel advancing direction of the caster based on the state information related to the state of the moving body; and

a control means for controlling for causing the moving body to accelerate in a second advancing direction different from a first advancing direction which is based on a target moving path for the moving body, depending on the result of the determination related to the wheel advancing direction.

### (Supplementary Note 24)

The movement control system according to supplementary note 23, wherein the control means is configured to control for causing the moving body to accelerate in the second advancing direction when it is determined that the caster is in a state of being difficult to swivel from the wheel advancing direction to the first advancing direction, depending on the result of the determination.

### (Supplementary Note 25)

The movement control system according to supplementary note 23 or 24, wherein the control means is configured to further control for causing the caster to accelerate in the second advancing direction to turn into the first advancing direction.

### (Supplementary Note 26)

The movement control system according to any one of supplementary notes 23 to 25, wherein the state of the moving body is a movement direction of the moving body before control for causing the moving body to move in the first advancing direction.

### (Supplementary Note 27)

The movement control system according to any one of supplementary notes 23 to 25, wherein the state of the moving body is a movement state of the moving body in response to control for causing the moving body to move in the first advancing direction.

### (Supplementary Note 28)

A program causing a computer to execute processing comprising:

obtaining information related to a state of a moving body which moves in response to a rotary motion of a caster having a swivel wheel with an eccentric structure;

determining a wheel advancing direction of the caster based on the state information related to the state of the moving body; and

controlling for causing the moving body to accelerate in a second advancing direction different from a first advancing direction which is based on a target moving path for the moving body, depending on the result of the determination related to the wheel advancing direction.

### INDUSTRIAL APPLICABILITY

A moving body which moves in response to a rotary motion of a caster having a swivel wheel with an eccentric structure can be efficiently moved to a target moving path.

### REFERENCE SIGNS LIST

1, 2 Movement Control System

100 Movement Control Apparatus

111, 150 Obtaining Section

120 Direction Determination Section

130 Control Section

200 Moving Body

210 Caster

211 Wheel

300, 301, 302 Transporting Apparatus

310 Elastic Mechanism

400 External Sensor Apparatus

What is claimed is:

1. A movement control method comprising:
obtaining state information related to a state of a moving body which moves in response to a rotary motion of a caster having a swivel wheel with an eccentric structure;
determining a wheel advancing direction of the caster based on the state information; and
controlling for causing the moving body to accelerate in a second advancing direction different from a first advancing direction which is based on a target moving path for the moving body, depending on the result of the determination related to the wheel advancing direction.

2. The movement control method according to claim 1, wherein controlling the moving body includes controlling for causing the moving body to accelerate in the second advancing direction when it is determined that the caster is in a state of being difficult to swivel from the wheel advancing direction to the first advancing direction, depending on the result of the determination.

3. The movement control method according to claim 1, wherein the state of the moving body is a movement direction of the moving body before control for causing the moving body to move in the first advancing direction.

4. The movement control method according to claim 1, wherein the state of the moving body is a movement state of the moving body in response to control for causing the moving body to move in the first advancing direction.

5. The movement control method according to claim 1, wherein the state information includes a movement direction obtained from movement information based on a captured image of the moving body.

6. The movement control method according to claim 1, wherein the state information includes measurement information obtained from one or more transporting apparatuses which transport the moving body.

7. The movement control method according to claim 6, wherein the one or more of the transporting apparatuses include two transporting apparatuses which transport the moving body in cooperation with each other.

8. The movement control method according to claim 1, further comprising
controlling for causing the moving body to accelerate in the second advancing direction when determination related to the wheel advancing direction of the caster is not successfully performed.

9. A movement control apparatus comprising:
a memory storing instructions; and
one or more processors configured to execute the instructions to:
obtain state information related to a state of a moving body which moves in response to a rotary motion of a caster having a swivel wheel with an eccentric structure;
determine a wheel advancing direction of the caster based on the state information related to the state of the moving body; and
control for causing the moving body to accelerate in a second advancing direction different from a first advancing direction which is based on a target moving path for the moving body, depending on the result of the determination related to the wheel advancing direction.

10. The movement control apparatus according to claim 9, wherein the one or more processors are is configured to execute the instructions to control for causing the moving body to accelerate in the second advancing direction when it is determined that the caster is in a state of being difficult to swivel from the wheel advancing direction to the first advancing direction, depending on the result of the determination.

11. The movement control apparatus according to claim 9, wherein the one or more processors are configured to further execute the instructions to control for causing the caster to accelerate in the second advancing direction to turn into the first advancing direction.

12. The movement control apparatus according to claim 9, wherein the state of the moving body is a movement direction of the moving body before control for causing the moving body to move in the first advancing direction.

13. The movement control apparatus according to claim 9, wherein the state of the moving body is a movement state of the moving body in response to control for causing the moving body to move in the first advancing direction.

14. A movement control system comprising one or more apparatuses each including a memory storing instructions and one or more processors configured to execute the instructions, the one or more apparatuses is configured to:
obtain state information related to a state of a moving body which moves in response to a rotary motion of a caster having a swivel wheel with an eccentric structure;
determine a wheel advancing direction of the caster based on the state information related to the state of the moving body; and
control for causing the moving body to accelerate in a second advancing direction different from a first advancing direction which is based on a target moving path for the moving body, depending on the result of the determination related to the wheel advancing direction.

15. The movement control system according to claim 14, wherein the one or more apparatuses is configured to control for causing the moving body to accelerate in the second advancing direction when it is determined that the caster is in a state of being difficult to swivel from the wheel advancing direction to the first advancing direction, depending on the result of the determination.

16. The movement control system according to claim 14, wherein the one or more apparatuses is configured to further control for causing the caster to accelerate in the second advancing direction to turn into the first advancing direction.

17. The movement control system according to claim 14, wherein the state of the moving body is a movement direction of the moving body before control for causing the moving body to move in the first advancing direction.

18. The movement control system according to claim 14, wherein the state of the moving body is a movement state of the moving body in response to control for causing the moving body to move in the first advancing direction.

19. (canceled)
